(19) United States
(12) Patent Application Publication
(10) Pub. No.: US 2022/0217953 A1
(43) Pub. Date: Jul. 14, 2022

(54) APPARATUS AND METHOD FOR COLLECTING LOOSENED FISH PARASITES IN A FISH PEN

(71) Applicant: Askvik Aqua AS, Hjelmeland (NO)

(72) Inventor: Rune Eritzland, Stavanger (NO)

(73) Assignee: Askvik Aqua AS, Hjelmeland (NO)

(21) Appl. No.: 17/609,696

(22) PCT Filed: May 7, 2020
(86) PCT No.: PCT/NO2020/050116

§ 371 Date: Nov. 8, 2021

(30) Foreign Application Priority Data
May 9, 2019 (NO) 20190594
Mar. 26, 2020 (NO) 20200358

(51) Int. Cl. A01K 61/13; A01K 63/04

(52) U.S. Cl. CPC A01K 61/13; A01K 63/047

(57) ABSTRACT

A sweep net is for crowding fish in a fish-farming pen. The sweep net has a fine-mesh net. A collecting device is for free fish parasites in a fish pen, a system is for collecting free fish parasites in a fish pen, and a method is for calculating the effect of a treatment against an external fish parasite in which the fish is treated outside a fish pen.

### CROSS-REFERENCE TO RELATED APPLICATIONS

This application is the U.S. national stage application of International Application PCT/NO2020/050116, filed May 7, 2020, which international application was published on Nov. 12, 2020, as International Publication WO 2020/226508 in the English language. The International Application claims priority of Norwegian Patent Application Nos. 20190594, filed May 9, 2019 and 20200358, filed Mar. 26, 2020. The international application and Norwegian applications are all incorporated herein by reference, in entirety.

### FIELD

The invention relates to a sweep net which is used for crowding fish in a fish-farming pen. More specifically, the invention relates to a fine-mesh sweep net that is provided with a net or netting that is so finely meshed that external fish parasites, which fall off the fish when the fish are being crowded with the sweep net, cannot move through the sweep net. The invention further relates to a system comprising the sweep net according to the invention, and a collecting apparatus for removing fish parasites that fall off the fish during crowding in the sweep net. The collecting apparatus comprises a collecting device that is positioned on the crowding side of the sweep net, and a handling unit for fish parasites that have fallen off in the sweep net. The fish parasite may be a crustacean parasite; in particular, the fish parasite may be salmon lice (Lepeophtheirus salmonis). The invention also comprises a sweep net which is so finely meshed that fish that are being crowded in the sweep net will not get injured by jaws, gill covers or gill arches and fins catching in the meshes of the sweep net. The invention also relates to a sweep net which is produced from a soft material which is gentle on the fish on contact between the fish and the sweep net.

### BACKGROUND

Fish-farming in closed enclosures involves a large number of fish being held together in a small area. This gives good conditions for parasites. In the farming of salmonoids, external crustacean parasites have become a problem. Especially salmon lice (L. salmonis) are present in large numbers. It is necessary to treat fish that are infected with salmon lice in order to keep the number of parasites down and to ensure the welfare of the fish.

Several of the bath treatments are carried out by the fish being guided into a pipe system or into tanks. This has the advantage of there being better control of the treatment time in relation to bath treatment of the fish in a fish pen. It also has the advantage of the amount of treatment solution being reduced. For some of the forms of treatment, such as the use of warm water, using pipes or tanks is a precondition for the method to work. Some of the forms of treatment may be combined with flushing the fish to wash off salmon lice.

Before the fish can be guided into a pipe system, the fish must be crowded together in the fish pen so that the fish may be pumped into the pipe system with a fish pump. It has turned out that salmon lice, especially the pre-adult and full-grown (adult) salmon lice, may loosen from the fish skin when the fish are being crowded together. Salmon lice that fall off may be alive, and these are capable of reinfecting fish. The salmon-louse females may drop their egg strings. The eggs may hatch and give new infectious salmon-louse larvae. Pre-adult salmon lice grow to be 3-5 mm long. Adult male lice will be 5-6 mm long and adult female lice will be 8-12 mm long.

It is therefore an advantage if salmon lice and egg strings that fall off the fish during crowding can be collected.

Crowding fish in a fish-farming pen is done by using a so-called casting net. A casting net like that is also referred to as a sweep net or sweep seine. In what follows, the term sweep net will be used. A sweep net comprises a net, also called netting. The net may be rectangular, or mainly rectangular with one or more truncated corners. The sweep net comprises a top line which may be provided with floats or other buoyant bodies. The sweep net further comprises a bottom line. The bottom line may be provided with weights, such as a lead line. The sweep net may be provided with lifting lugs at the corners. There are no requirements for the mesh size of the net beyond making it impossible for the fish in the fish-farming pen to swim through the sweep net. Typically, the mesh size of the sweep net will be the same size as the mesh size of the fish-farming pen.

A sweep net may be of various sizes, and the size may be adapted to the size of the fish-farming pen in which the fish are to be crowded together. A sweep net may be from 10 to 100 metres wide and from 5 to 50 metres deep. Typically, a sweep net may be 65 m long and 30 m deep.

The sweep net is put into the fish-farming pen on the opposite side to where it has been planned for the fish pump to suck fish out of the fish-farming pen. The sweep net is lowered into the fish-farming pen in such a way that the top line with buoyancy means is floating in the water surface inside the fish-farming pen. The lower part of the sweep net is weighted down by weights or a lead line, and therefore the sweep net first stands as a vertical wall inside the fish-farming pen. Traces are attached to the lifting lugs and, by the traces being pulled, the sweep net is moved towards the inlet of the fish pump. The traces that are attached to the bottom lifting lugs are pulled in faster than the traces attached to the upper lifting lugs. The sweep net will slowly be puckered up into a bag. To begin with, the fish in the fish pen will be able to swim past the sweep net, but fish that are within the sweep net as it becomes completely puckered-up, will be trapped. The fish are crowded together by the net being pulled further up, and the fish then have a density which is suitable for them to be sucked into the fish pump. The sweep net is pulled further up until all the fish in the sweep net have been sucked into the pump.

It is common to repeat this four to five times in a fish-farming pen in order to empty the fish pen completely of fish.

It is known that some fish become injured by a relatively coarse-mesh sweep net. The jaws may catch in the net meshes when the fish are tight together. It is also known that gill covers and gill arches may catch in the net meshes. It is also known that fins, especially pectoral fins may catch in the net meshes so that the fins are torn off.

It is also known that many salmon lice fall off the fish skin when the fish are crowded in a sweep net. As much as 40% to 60% of the mobile stages of salmon lice may fall off. The mobile stages comprise pre-adult and adult salmon lice. As mentioned above, these loosened salmon lice may re-infect fish. It is also more difficult to measure how effective a treatment of the fish is, when it is actually not known how many external fish parasites are stuck to the fish before treatment. Without being bound by theory, it is possible that fish that get stuck in the net meshes and thereby get a panic-like behaviour, trigger a stress reaction in the other fish, which can be seen from their swimming behaviour. It is further possible that the stress reaction releases stress-related compounds in the mucus layer of the fish. Salmon lice may possibly register the changed composition of the mucus layer and then leave the host fish.

Crowding fish with a sweep net is also done when the fish are to be transferred from a fish pen to a well boat for the fish to be transported to a salmon slaughterhouse. Crowding fish with a sweep net is also done in other connections when a fish pen is to be emptied of fish.

### SUMMARY

The invention has for its object to remedy or reduce at least one of the drawbacks of the prior art or at least provide a useful alternative to the prior art.

The object is achieved through the features that are specified in the description below and in the claims that follow.

The invention is defined by the independent claims. The dependent claims define advantageous embodiments of the invention.

In a first aspect, the invention relates, more specifically, to a sweep net for crowding fish in a fish pen, and the sweep net comprises a fine-mesh net. By a fine-mesh net is meant, here, that the mesh size is adapted for pre-adult and adult fish parasites, especially salmon lice (L. salmonis), not to be able to pass through the meshes of the net. Egg strings may also be retained by the fine-mesh net.

The mesh size of the sweep net may be between 1.1 mm and 10 mm. The mesh size of the sweep net may be between 1.1 and 7.5 mm. Alternatively, the mesh size may be between 1.1 mm and 5 mm. Alternatively, the mesh size may be between 2.0 mm and 10 mm. Alternatively, the mesh size may be between 2.0 mm and 7.5 mm. Alternatively, the mesh size may be between 2.0 mm and 5 mm. Alternatively, the mesh size may be larger than 1.1 mm, or larger than 1.5 mm, or larger than 2.0 mm. Alternatively, the mesh size may be smaller than 10 mm, or smaller than 7.5 mm, or smaller than 5 mm or smaller than 4 mm, or smaller than 3 mm. The mesh size may be within an interval as stated by combining any of the preceding given largest and smallest mesh sizes.

The invention also relates to a collecting device for free fish parasites in a mass of water in a fish pen, the collecting device comprising a sweep net as described hereinbefore.

The invention also relates to a system for collecting free parasites in a mass of water, wherein the system comprises the sweep net as described hereinbefore, and the sweep net may form an outer side and an opposite crowding side, and the system may be provided with a collecting apparatus for an external fish parasite. This has the advantage of loosened fish parasites being actively removed from the water within the fish-farming pen by the system. In particular, fish parasites that do not attach to the sweep net will be removed by the system.

The collecting apparatus may comprise a collecting device for an external fish parasite on the crowding side of the sweep net. The collecting device may comprise a perforated pipe. The perforated pipe may be in fluid communication with the suction side of a pump. The pump may be placed on a vessel. In an alternative embodiment, the pump may be submerged. In an alternative embodiment, the pump may be submerged and positioned on the free end portion of the pipe, so that the perforated pipe is positioned on the pressure side of the pump.

The system may comprise a handling unit for a fish parasite on the pressure side of the pump. The perforated pipe may be in fluid communication with the handling unit. The handling unit may comprise a filtering unit which separates fish parasites from the water flowing through the filter unit. The handling unit may comprise a channel provided with electrodes. Fish parasites in the water flowing through the channel may be subjected to a lethal electric field or at least an electric field that causing lasting harm to the fish parasite so that it is no longer infectious.

In an alternative embodiment, the system for collecting free fish parasites in a mass of water may comprise a sweep net as described hereinbefore, and the system may comprise:
a fish pump arranged to carry fish, water and free fish parasites in the water from the sweep net;
a treatment unit for fish infected with a fish parasite; and
a collecting unit arranged to retain the free fish parasites in the water and fish parasites that have loosened from the fish in the treatment unit.

In a second aspect, the invention relates to a method for calculating the effect of a treatment against an external fish parasite, in which the fish is treated outside a fish pen, the method comprising the steps of:

a) catching a representative number of fish from the fish pen;
b) counting the number of external fish parasites and calculating an average number of fish parasites per fish;
repeatedly:
c) crowding the fish together in the fish pen with a sweep net;
d) guiding the crowded fish through an appropriate treatment unit; and
e) guiding the treated fish into a suitable receiving tank;
and
f) picking a representative number of fish after the treatment unit, counting the number of remaining external fish parasites and calculating an average number of remaining fish parasites per fish,
and the method, in step c), comprising the use of a sweep net comprising a fine-mesh net.

The method may comprise using a sweep net which comprises a soft material. The method may comprise using a sweep net with a mesh size of between 1.1 mm and 10 mm. The mesh size of the sweep net may be between 1.1 and 7.5 mm. Alternatively, the mesh size may be between 1.1 mm and 5 mm. Alternatively, the mesh size may be between 2.0 mm and 10 mm. Alternatively, the mesh size may be between 2.0 mm and 7.5 mm. Alternatively, the mesh size may be between 2.0 mm and 5 mm. Alternatively, the mesh size may be larger than 1.1 mm or larger than 1.5 mm, or larger than 2.0 mm. Alternatively, the mesh size may be smaller than 10 mm, or smaller than 7.5 mm, or smaller than 5 mm or smaller than 4 mm, or smaller than 3 mm. The mesh size may be within an interval as stated by combining any of the preceding given largest and smallest mesh sizes.

### BRIEF DESCRIPTION OF THE DRAWINGS

In what follows, an example of a preferred embodiment is described, which is visualized in the accompanying drawings, in which:

FIGS. 1A-B show schematically a sweep net in two prior-art embodiments; and

FIG. 2 shows schematically a system for collecting a fish parasite in accordance with the invention.

### DETAILED DESCRIPTION OF THE DRAWINGS

In the figures, the reference numeral 100 indicates a prior-art sweep net. The sweep net 100 comprises a net 110. At an edge, the sweep net 100 comprises a top line 120 which is provided with a plurality of buoyant bodies 122. On the opposite side from that of the top line 120, the sweep net 100 comprises a bottom line 130. The bottom line 130 may be provided with weights (not shown), or the bottom line 130 may comprise a lead line (not shown). The sweep net 100 is provided with a lifting lug 140 at each corner. Traces (not shown) are attached to the lifting lugs 140.

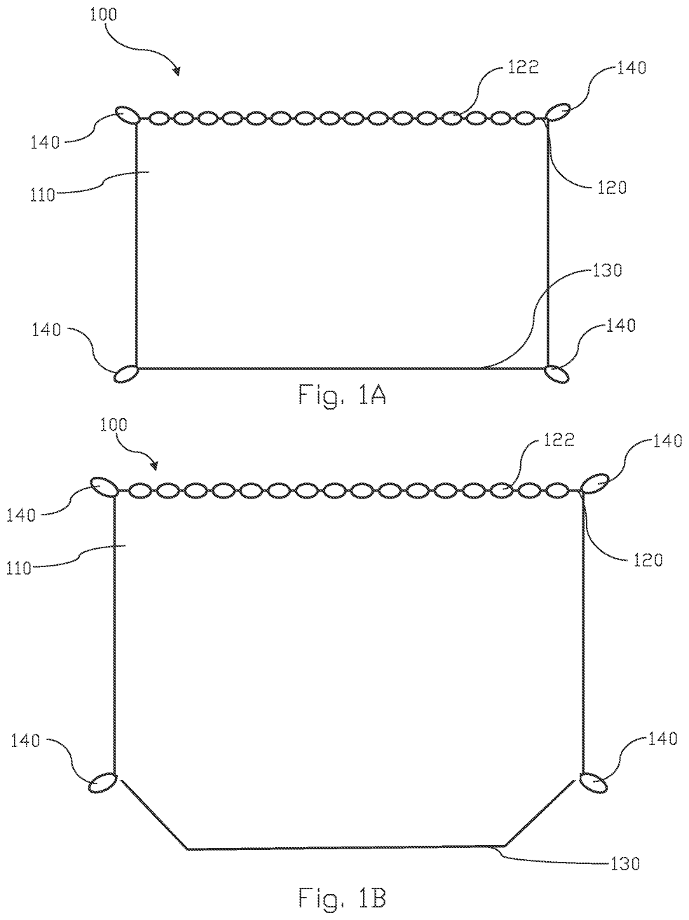

The sweep net 100 may be of a rectangular shape, as shown in FIG. 1A. The sweep net 100 may be formed with truncated corners, as shown in FIG. 1B.

According to the invention, the sweep net 1 is formed in the same way as known sweep nets 100, the difference being that the net 110 is replaced with a fine-mesh net 10. The mesh size of the fine-mesh net 10 is chosen to be such that external fish parasites, such as pre-adult and adult crustacean parasites (not shown), cannot move through the fine-mesh net 10. The crustacean parasite may be a salmon louse (L. salmonis). The mesh size may be smaller than 10 mm, such as smaller than 7.5 mm, such as smaller than 5 mm, such as smaller than 4 mm, such as smaller than 3 mm. The mesh size may be larger than 1.1 mm, such as larger than 1.5 mm, such as larger than 2 mm.

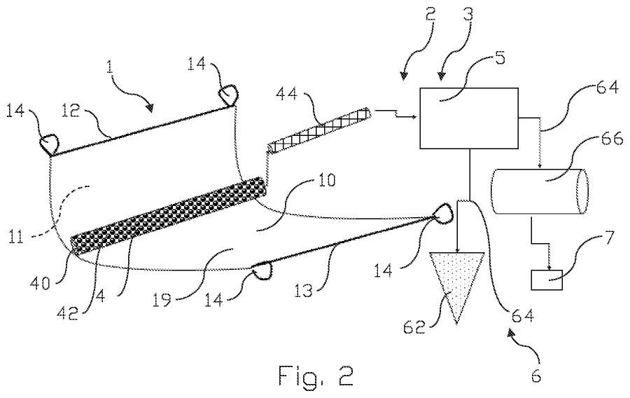

The sweep net 1 comprises the net 10. At an edge, the sweep net 1 comprises a top line 12 which is provided with a plurality of buoyant bodies (not shown in FIG. 2). On the opposite side from that of the top line 12, the sweep net 1 comprises a bottom line 13. The bottom line 13 may be provided with weights (not shown), or the bottom line 13 may comprise a lead line (not shown). The sweep net 1 is provided with a lifting lug 14 at each corner. Traces (not shown) are attached to the lifting lugs 14. The net 10 forms an outer side 11 and a crowding side 19. The crowding side 19 faces the fish during crowding. The outer side 11 is the opposite side of the net 10 relative to the crowding side 19.

The invention also relates to a system 2. The system 2 comprises the sweep net 1 and a collecting apparatus 3 for collecting fish parasites which have fallen off fish (not shown) during crowding in a fish-farming pen (not shown).

The collecting apparatus 3 comprises a collecting device 4 which is positioned on the crowding side 19 of the sweep net 1. In one embodiment, the collecting device 4 is formed of a perforated pipe 42. The perforated pipe 42 may be closed in a free end portion 40. At an opposite end portion 49, the perforated pipe 42 may be connected to a hose 44. The system 2 comprises a pump 5 in fluid communication with the hose 44 on the suction side of the pump 5.

The system 2 comprises a handling unit 6 for fish parasites. The handling unit 6 is in fluid communication with the pump 5 on the pressure side of the pump 5. A channel 64 carries water containing fish parasites from the pump to the handling unit 6. In one embodiment, the handling unit 6 may comprise a filter unit 62. The fish parasites are retained by the filter unit 62 while water passes through the filter unit 62. In another embodiment, the handling unit 62 comprises a chamber 66 provided with electrodes (not shown). The electrodes are supplied with electrical energy from a source (not shown). An electric field is formed between the electrodes inside the chamber 66. Fish parasites flowing through the chamber 66 are subjected to the electric field. The electric field has a strength and a character that at least inflict lasting damage on the fish parasites so that they are no longer infectious. The electric field may be lethal to the fish parasites. The water that flows through the chamber 66 then flows to a drain 7.

The handling unit 6 may comprise the water flowing first through the filter unit 62 and then through the chamber 64 before the water flows to the drain 7. The handling unit 6 may comprise the water flowing first through the chamber 64 and then through the filter unit 62 before the water flows to the drain 7.

The pump 5 and the handling unit 6 may be positioned on a vessel (not shown).

In an alternative embodiment (not shown), the pump 5 may be submerged and positioned between the collecting device 4 and the handling unit 6. In another embodiment (not shown), the pump 5 may be submerged and positioned at the free end portion 40 of the collecting device 4. In this embodiment, the collecting device 4 will be positioned on the pressure side of the pump 5.

In an alternative embodiment (not shown), loosened fish parasites may be sucked up in the water together with the fish that are crowded together in the sweep net 1. Water, fish and fish parasites are carried through a fish pump (not shown) into a suitable treatment unit (not shown) for fish with external fish parasites such as crustacean parasites to be treated. Free fish parasites will be separated from the sucked-up water together with fish parasites that are separated from the fish inside the treatment unit and be collected in a suitable collecting unit, such as a filter (not shown).

A fish pump like that creates such a strong current through the fine-mesh sweep net that free fish parasites will not manage to swim against the current, and the fish parasites will be carried into the fish pump and then into the treatment unit. Since the sweep net 1 is puckered up as it is being emptied of fish, most of the loosened parasites will be sucked up. The sweep net according to the invention is therefore also a collecting device for free fish parasites, such as pre-adult and adult crustacean parasites, in a mass of water.

The sweep net 1 is used for crowding fish in a fish-farming pen in a known manner. After each crowding or after the fish pen has been emptied of all the fish, the sweep net 1 may be hoisted and immersed in a vessel (not shown) containing a solution which is lastingly harmful to fish parasites. The solution may be lethal to fish parasites.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1.-13. (canceled)

14. A sweep net for crowding fish in a fish pen, wherein the sweep net comprises a fine-mesh net having a mesh size between 1.1 mm and 10 mm.

15. The sweep net according to claim 14, wherein the sweep net comprises a soft material.

16. The sweep net according to claim 14, wherein the mesh size is more particularly between 1.1 mm and 5 mm.

17. A collecting device for free fish parasites in a mass of water in a fish pen, the collecting device comprising a sweep net, and the sweep net comprising a fine-mesh net having a mesh size between 1.1 mm and 10 mm.

18. A system for collecting free fish parasites in a mass of water, wherein the system comprises a sweep net for crowding fish in a fish pen, the sweep net comprising a fine-mesh net having a mesh size of between 1.1 mm and 10 mm, wherein the sweep net forms an outer side and an opposite crowding side, and wherein the system further comprises a collecting apparatus for an external fish parasite.

19. The system according to claim 18, wherein the collecting apparatus comprises a collecting device for an external fish parasite positioned on the crowding side of the sweep net.

20. The system according to claim 19, wherein the collecting device comprises a perforated pipe.

21. The system according to claim 20, wherein the perforated pipe is in fluid communication with a suction side of a pump.

22. The system according to claim 20, wherein the system comprises a handling unit for a crustacean parasite, the handling unit being in fluid communication with a pump on the pressure side of the pump.

23. The system according to claim 18, further comprising:
a fish pump arranged to carry fish, water and free fish parasites in the water from the sweep net;
a treatment unit for fish infected with a fish parasite; and
a collecting unit arranged to retain the free fish parasites in the water and fish parasites that have loosened from the fish in the treatment unit.

24. A method for calculating an effect of a treatment against an external fish parasite in which the fish is treated outside a fish pen, the method comprising the steps of:
a) catching a representative number of fish from the fish pen;
b) counting the number of external fish parasites and calculating an average number of fish parasites per fish;
repeatedly:
c) crowding the fish together in the fish pen with a sweep net;
d) guiding the crowded fish through a suitable treatment unit;
e) guiding the treated fish into a suitable receiving tank; and
f) picking a representative number of fish after the treatment unit, counting the number of remaining external fish parasites and calculating an average number of remaining fish parasites per fish,
wherein in step c, the method comprises using a sweep net comprising a fine-mesh net.

25. The method according to claim 24, wherein the sweep net comprises a soft material.
